(19) United States
(12) Patent Application Publication
(10) Pub. No.: US 2018/0211577 A1
(43) Pub. Date: Jul. 26, 2018

(54) RGBW PIXEL RENDERING DEVICE AND METHOD

(71) Applicant: WUHAN CHINA STAR OPTOELECTRONICS TECHNOLOGY CO., LTD., Wuhan, Hubei (CN)

(72) Inventors: Biao PAN, Shenzhen, Guangdong (CN); Xinhui ZHONG, Shenzhen, Guangdong (CN)

(73) Assignee: Wuhan China Star Optoelectronics Technology Co., Ltd., Wuhan, Hubei (CN)

(21) Appl. No.: 15/328,898

(22) PCT Filed: Dec. 29, 2016
(86) PCT No.: PCT/CN2016/113104

§ 371 Date: Jan. 24, 2017

(30) Foreign Application Priority Data
Dec. 27, 2016 (CN) 201611229628.4

(51) Int. Cl. G09G 3/20; G09G 3/3208

(52) U.S. Cl. CPC G09G 3/2003; G09G 2320/0626; G09G 2320/0673; G09G 3/3208

(57) ABSTRACT

The disclosure provides a RGBW pixel rendering device, including a collecting module obtaining a RGB grayscale value, converters converting the RGB grayscale value to a RGB brightness value and converting a second RGBW brightness value to a RGBW grayscale value to be output, a sampler, converting the RGB brightness value to a first RGBW brightness value, a judging element obtaining saturation values and brightness values, and calculating the saturation values and the brightness values respectively to obtain a saturation value difference and a brightness value difference for judging, a rendering element rendering the first RGBW brightness value according to an outcome to obtain the second RGBW brightness values. The disclosure further provides a rendering method. Compared with the prior art, the display has relatively high resolution without losing details.

### TECHNICAL FIELD

The disclosure relates to a liquid crystal display technology, and more particularly to a RGBW pixel rendering device and a method.

### DESCRIPTION OF RELATED ART

Defects of a conventional three primary colored display system are exposing with development of living standard and constant improvement of display technique, an increasing requirement can hardly be satisfied. It is mainly reflected in reduction of aperture ratio of pixels and optical transmittance of a screen caused by enhancement of screen resolution, resulting in additional power consumption of backlight and the entire screen.

Unlike a conventional RGB display, a RGBW display includes a white (W) sub-pixel besides red (R), green (G) and blue (B) sub-pixels. Attendance of the white sub-pixel can significantly improve transmittance of a LCD and luminous efficiency of unit area in an OLED display, accordingly to chase objectives of low power consumption, energy saving and environmental protection.

In the same design of pixels, as an extra W sub-pixel in RGBW, the physical resolution will be reduced correspondingly. In a RGBW display device, in order to raise the actual resolution of the display, a method of sub-pixel rendering (SPR) is required to be adopted.

However, the RGBW display device based on a conventional SPR method will lose details to an extent caused by loss of partial sub-pixel information in a conversion process from input RGB signals to output RGBW signals. Meanwhile, words and images are totally different display contents, but the conventional SPR method treats words and images in an identical manner, the manner will lead to numerous problems such as insufficient brightness of the words in display, obscure of details and failure in displaying smoothly of images.

Therefore, a RGBW pixel rendering method processing words and images respectively to ensure the display having relatively high resolution with full details is desiderated.

### SUMMARY

The disclosure provides a RGBW pixel rendering device and a method to guarantee the display device has relatively high resolution without losing details in display.

The disclosure provides a RGBW pixel rendering device, the rendering device includes a collecting module, converters, a sampler, a judging element and a rendering element.

The collecting module is configured to obtain a RGB grayscale value of three primary color components of each pixel of an original image in a RGB color space and send the RGB grayscale value to the converters.

The converters are configured to obtain a brightness value of RGB by De-Gamma conversion of the RGB grayscale value and send the brightness value of RGB to the sampler, as well as obtaining a RGBW grayscale value of a pixel by Gamma conversion of a second RGBW brightness value and outputting the RGBW grayscale value.

The sampler is configured to convert the brightness value of RGB to a first RGBW brightness value and send the first RGBW brightness value to the rendering element.

The judging element is configured to obtain saturation values and brightness values of two pixels in each group in the original image with two pixels as a group, and obtain a saturation difference and a brightness difference by respective subtraction of the saturation values and the brightness values; judging according to the saturation difference and the brightness difference of two pixels in each of the groups to obtain an outcome and sending the outcome to the rendering element.

The rendering element is configured to render the first RGBW brightness value according to the outcome to obtain the second RGBW brightness value after rendering and send the second RGBW brightness value to the converters for conversion.

Optionally, the converters include a first converter and a second converter.

The first converter is configured to obtain the brightness value of RGB by De-Gamma conversion of the RGB grayscale value and send the brightness value of RGB to the sampler.

The second converter is configured to obtain the RGBW grayscale value of the pixel by Gamma conversion of the second RGBW brightness value and output the RGBW grayscale value.

Optionally, a judging criterion of the judging element determining according to the saturation difference and the brightness difference of two pixels in each of the groups is judging if the saturation differences of each of the groups are all less than a first threshold and the brightness differences of each of the groups are all more than a second threshold, if the saturation differences of each of the groups are all less than the first threshold and the brightness differences of each of the groups are all more than the second threshold, the judging element votes the original image to be a word mode, otherwise, the judging element votes the original image to be an image mode.

Optionally, when the outcome is the image mode, the rendering element renders by averaging a sum of the brightness values of sub-pixels of an identical type in the first RGBW brightness values of two pixels of each of the groups to obtain the second RGBW brightness value.

Optionally, when the outcome is the word mode, the rendering element calculates total brightness values of the first RGBW brightness values of two pixels of each of the groups respectively, and judges the total brightness values of the two pixels to obtain the corresponding second RGBW brightness value, calculation of the total brightness value of the pixels follows a formula below:

$${P}_{n} = {W}_{n} + \frac{{R}_{n} + {G}_{n} + {B}_{n}}{3}$$

Brightness values of four sub-pixels included in the first RGBW brightness value of the pixel are respectively Wₙ, Rₙ, Gₙ and Bₙ, n is a serial number of a position where the pixel is in the original image, Pₙ is the total brightness value of the pixel, the formula above obtains the total brightness value of the first RGBW brightness value of the pixel.

When the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value.

When the total brightness value of the pixels on the left is smaller than the total brightness value of the pixels on the right, the total brightness of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.

The disclosure further provides a RGBW pixel rendering method, including following steps.

Step one S01, a collecting module obtains a RGB grayscale value of three primary color components of each pixel of an original image in a RGB color space, and sends the RGB grayscale value to converters.

Step two S02, the converters obtain a brightness value of RGB by De-Gamma conversion of the RGB grayscale value and send the brightness value of RGB to a sampler.

Step three S03, the sampler converts the brightness value of RGB to a first RGBW brightness value and sends the first RGBW brightness value to a rendering element.

Step four S04, a judging element obtains saturation values and brightness values of two pixels in each group in the original image with two pixels as a group, and obtains a saturation difference and a brightness difference by respective subtraction of the saturation values and the brightness values, the judging element obtains an outcome according to the saturation difference and the brightness difference of two pixels in each group and sends the outcome to the rendering element.

Step five S05, the rendering element renders the first RGBW brightness value according to the received outcome to obtain the rendered second RGBW brightness value and sends the second RGBW brightness value to the converters for conversion.

Step six S06, the converters obtain a RGBW grayscale value of a pixel by Gamma conversion of a second RGBW brightness value and output the RGBW grayscale value.

Optionally, the converters include a first converter and a second converter.

After the collecting module sends the RGB grayscale value to the converter, the first converter obtains the brightness value of RGB by De-Gamma conversion of the RGB grayscale value and sends the brightness value of RGB to the sampler.

After the rendering element sends the rendered second RGBW brightness value to the converters, the second converter obtains a RGBW grayscale value of the pixel by Gamma conversion of the second RGBW brightness value and outputs the RGBW grayscale value.

Optionally, a judging criterion of the judging element determining according to the saturation difference and the brightness difference of two pixels in each of the groups in the step four S04 is judging if the saturation differences of each of the groups are all less than a first threshold and the brightness differences of each of the groups are all more than a second threshold, if the saturation differences of each of the groups are all less than the first threshold and the brightness differences of each of the groups are all more than the second threshold, the judging element votes the original image to be a word mode, otherwise, the judging element votes the original image to be an image mode.

Optionally, when the outcome is the image mode, the rendering element renders by averaging a sum of the brightness values of sub-pixels of an identical type in the first RGBW brightness values of two pixels of each of the groups to obtain the second RGBW brightness value.

Optionally, when the outcome is the word mode, the rendering element calculates total brightness values of the first RGBW brightness values of two pixels of each of the groups respectively, and judges the total brightness value of the two pixels to obtain the corresponding second RGBW brightness value, calculation of the total brightness value of the pixels follows a formula below:

$${P}_{n} = {W}_{n} + \frac{{R}_{n} + {G}_{n} + {B}_{n}}{3}$$

Brightness values of four sub-pixels included in the first RGBW brightness value of the pixel are respectively Wₙ, Rₙ, Gₙ and Bₙ, n is a serial number of a position where the pixel is in the original image, Pₙ is the total brightness value of the pixel, the formula above obtains the total brightness value of the pixel.

When the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value.

When the total brightness value of the pixels on the left is smaller than the total brightness value of the pixels on the right, the total brightness value of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.

Compared with the prior art, the disclosure obtains the grayscale value of three primary color components of each pixel of an original image in a RGB color space and converts to the RGB brightness value, and obtains the second RGBW grayscale value by Gamma conversion according to different display modes after converting the RGB brightness value to the RGBW brightness value and outputs the second RGBW grayscale value, so that the display has relatively high resolution without losing details, words and images are processed respectively. Images are processed to be displayed more smoothly, words are processed to be brightened to clarify details.

### BRIEF DESCRIPTION OF THE DRAWINGS

FIG. 1 is a structural block diagram of a RGBW rendering device according to the disclosure.

FIG. 2 is a flowchart of a rendering method according to the disclosure.

FIG. 3 is a schematic view of pixel rendering in an image mode according to the disclosure.

FIG. 4 is a schematic view of pixel rendering in a word mode according to the disclosure.

### DETAILED DESCRIPTION OF PREFERRED EMBODIMENTS

Embodiments of the disclosure will be described in detail with reference to the accompanying drawings as follows.

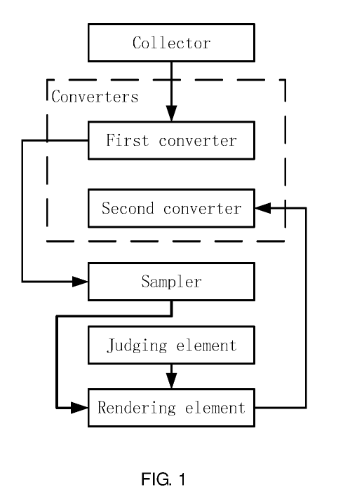

As shown in FIG. 1, a RGBW pixel rendering device of the disclosure includes a collecting module, converters, a sampler, a judging element and a rendering element.

The collecting module is configured to obtain a RGB grayscale value of three primary color components of each pixel of an original image in a RGB color space and send the RGB grayscale value to the converters.

The converters are configured to obtain a brightness value of RGB by De-Gamma conversion of the RGB grayscale value and send the brightness value of RGB to the sampler, as well as obtaining a RGBW grayscale value of a pixel by Gamma conversion of a second RGBW brightness value and outputting the RGBW grayscale value.

The sampler is configured to convert the brightness value of RGB to a first RGBW brightness value and send the first RGBW brightness value to the rendering element.

The judging element is configured to obtain saturation values and brightness values of two pixels in each group in the original image with two pixels as a group, and obtain a saturation difference and a brightness difference by respective subtraction of the saturation values and the brightness values; judging according to the saturation difference and the brightness difference of two pixels in each of the groups to obtain an outcome and sending the outcome to the rendering element.

The rendering element is configured to render the first RGBW brightness value according to the outcome to obtain the second RGBW brightness value after rendering and send the second RGBW brightness value to the converters for conversion.

Optionally, the converters of the disclosure include a first converter and a second converter.

The first converter is configured to obtain the brightness value of RGB by De-Gamma conversion of the RGB grayscale value and send the brightness value of RGB to the sampler.

The second converter is configured to obtain the RGBW grayscale value of the pixel by Gamma conversion of the second RGBW brightness value and output the RGBW grayscale value.

A judging criterion of the judging element determining according to the saturation difference and the brightness difference of two pixels in each of the groups is judging if the saturation differences of each of the groups are all less than a first threshold and the brightness differences of each of the groups are all more than a second threshold, if the saturation differences of each of the groups are all less than the first threshold and the brightness differences of each of the groups are all more than the second threshold, the judging element votes the original image to be a word mode, otherwise, the judging element votes the original image to be an image mode, the first threshold is 1.3, the second threshold is 0.3.

When the outcome is the image mode, the rendering element renders by averaging a sum of the brightness values of sub-pixels of an identical type in the first RGBW brightness values of two pixels of each of the groups to obtain the second RGBW brightness value.

When the outcome is the word mode, the rendering element calculates total brightness values of the first RGBW brightness values of two pixels of each of the groups respectively, and judges the total brightness values of the two pixels to obtain the corresponding second RGBW brightness value.

When the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value.

When the total brightness value of the pixel on the left of the two pixels in each of the groups is smaller than the total brightness value of the pixel on the right of the two pixels in each of the groups, the total brightness of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.

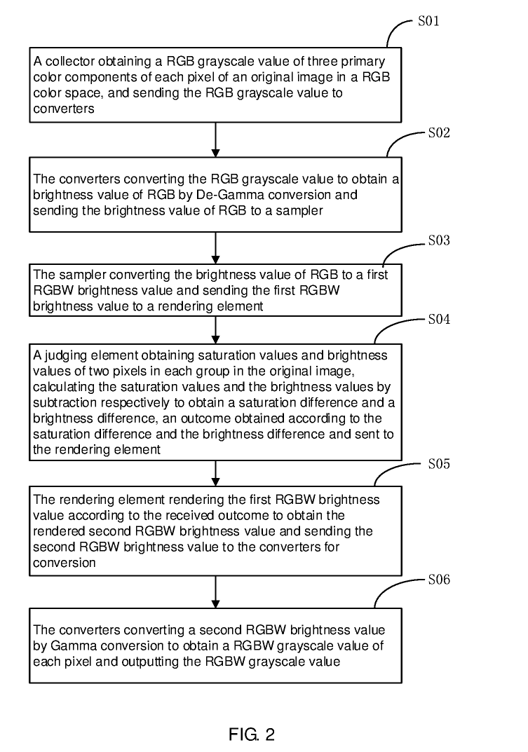

As shown in FIG. 2, a RGBW pixel rendering method of the disclosure includes following steps.

Step one S01, a collecting module obtains a RGB grayscale value of three primary color components of each pixel of an original image in a RGB color space, and sends the RGB grayscale value to converters.

Step two S02, the converters obtain a brightness value of RGB by De-Gamma conversion of the RGB grayscale value and send the brightness value of RGB to a sampler.

Step three S03, the sampler converts the brightness value of RGB to a first RGBW brightness value and sends the first RGBW brightness value to a rendering element.

Step four S04, a judging element obtains saturation values and brightness values of two pixels in each group in the original image with two pixels as a group, and obtains a saturation difference and a brightness difference by respective subtraction of the saturation values and the brightness values, the judging element obtains an outcome according to the saturation difference and the brightness difference of two pixels in each group and sends the outcome to the rendering element.

Step five S05, the rendering element renders the first RGBW brightness value according to the received outcome to obtain the rendered second RGBW brightness value and sends the second RGBW brightness value to the converters for conversion.

Step six S06, the converters obtain a RGBW grayscale value of a pixel by Gamma conversion of a second RGBW brightness value and output the RGBW grayscale value.

Optionally, the converters include a first converter and a second converter.

After the collecting module sends the RGB grayscale value to the converter, the first converter obtains the brightness value of RGB by De-Gamma conversion of the RGB grayscale value and sends the brightness value of RGB to the sampler.

After the rendering element sends the rendered second RGBW brightness value to the converters, the second converter obtains a RGBW grayscale value of the pixel by Gamma conversion of the second RGBW brightness value and outputs the RGBW grayscale value.

A judging criterion of the judging element determining according to the saturation difference and the brightness difference of two pixels in each of the groups in the step S04 is judging if the saturation differences of each of the groups are all less than a first threshold and the brightness differences of each of the groups are all more than a second threshold, if the saturation differences of each of the groups are all less than the first threshold and the brightness differences of each of the groups are all more than the second threshold, the judging element votes the original image to be a word mode, otherwise, the judging element votes the original image to be an image mode.

When the outcome is the image mode, the rendering element renders by averaging a sum of the brightness values of sub-pixels of an identical type in the first RGBW brightness values of two pixels of each of the groups to obtain the second RGBW brightness value.

When the outcome is the word mode, the rendering element calculates total brightness values of the first RGBW brightness values of two pixels of each of the groups respectively, and judges the total brightness value of the two pixels to obtain the corresponding second RGBW brightness value.

When the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value.

When the total brightness value of the pixel on the left of the two pixels in each of the groups is smaller than the total brightness value of the pixel on the right of the two pixels in each of the groups, the total brightness value of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.

Two as a group sequentially in the disclosure is specifically according to positions of pixels in the original image with a sequence in each line, two pixels are as one group, such as positions of pixels in the first line are 1, 2, 3, 4, 5, 6, 7, 8, . . . , in the first line, pixels on positions 1 and 2 are as a group, pixels on positions 3 and 4 are as a group, pixels on positions 5 and 6 are as a group, pixels on positions 7 and 8 are as a group, so on and so forth.

When the disclosure judges the outcome to be the image mode, the rendering element renders by averaging a sum of sub-pixels of an identical type in two pixels of each of the groups to obtain the second RGBW brightness value.

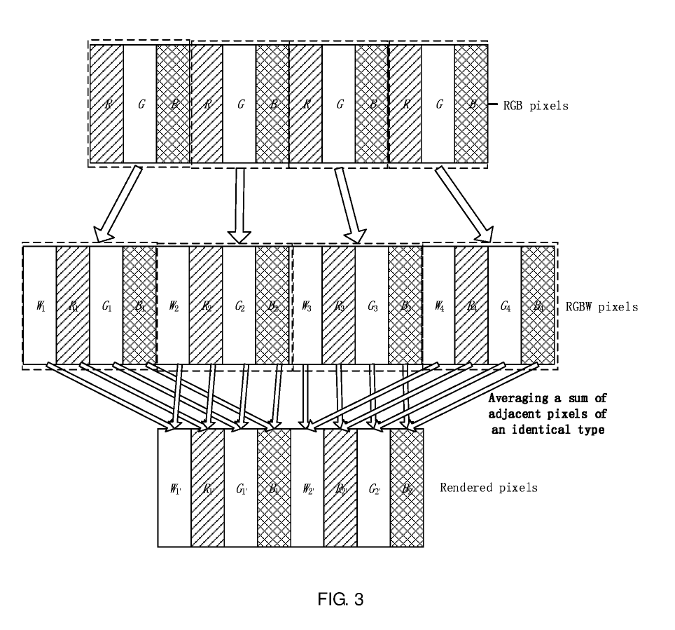

Specifically as shown in FIG. 3, brightness values of sub-pixels included in the first RGBW brightness value of each of the pixels are supposed to be (Wₙ, Rₙ, Gₙ; Bₙ), n is a serial number of a position where the pixel is in the original image, four pixels are adopted to be an example, the four pixels are respectively (W₁, R₁, G₁, B₁), (W₂, R₂, G₂, B₂), (W₃, R₃, G₃, B₃), (W₄, R₄, G₄, B₄), via formulas:

$$\{ \begin{matrix}{W}_{{1}^{′}} = \frac{( {W}_{1} + {W}_{2} )}{2} \\ {R}_{{1}^{′}} = \frac{( {R}_{1} + {R}_{2} )}{2} \\ {G}_{{1}^{′}} = \frac{( {G}_{1} + {G}_{2} )}{2} \\ {B}_{{1}^{′}} = \frac{( {B}_{1} + {B}_{2} )}{2}\end{matrix} , \{ \begin{matrix}{W}_{{2}^{′}} = \frac{( {W}_{3} + {W}_{4} )}{2} \\ {R}_{{2}^{′}} = \frac{( {R}_{3} + {R}_{4} )}{2} \\ {G}_{{2}^{′}} = \frac{( {G}_{3} + {G}_{4} )}{2} \\ {B}_{{2}^{′}} = \frac{( {B}_{3} + {B}_{4} )}{2}\end{matrix}$$

Finally, the second RGBW brightness values are obtained respectively, the result is to smooth transition among adjacent pixels in the image display mode. An image, especially a portrait, will has a more ideal display effect. The photo-editing function in some photo processors is exactly the smooth method.

When the disclosure judges the outcome to be the word mode, the rendering element obtains the corresponding second RGBW brightness value according to the total brightness value of two adjacent pixels.

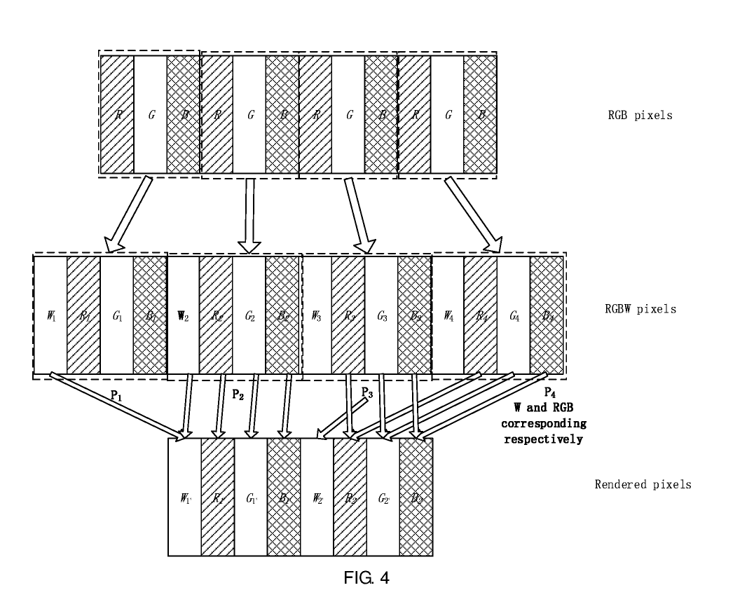

Specifically as shown in FIG. 4, brightness values of four sub-pixels included in the first RGBW brightness value of the pixel are supposed to be (Wₙ, Rₙ, Gₙ, Bₙ), n is a serial number of a position where the pixel is in the original image, Pₙ is the total brightness value of the pixel, the formula is as follows.

$${P}_{n} = {W}_{n} + \frac{{R}_{n} + {G}_{n} + {B}_{n}}{3}$$

Four pixels are taken as an example, brightness values of four sub-pixels in the first RGBW brightness value of the four pixels are respectively (W₁, R₁, G₁, B₁), (W₂, R₂, G₂, B₂), (W₃, R₃, G₃, B₃), (W₄, R₄, G₄, B₄), the total brightness values Pₙ of the four pixels can be achieved by the following formula respectively.

$$\{ \begin{matrix}{P}_{1} = {W}_{1} + \frac{( {R}_{1} + {G}_{1} + {B}_{1} )}{3} \\ {P}_{2} = {W}_{2} + \frac{( {R}_{2} + {G}_{2} + {B}_{2} )}{3} \\ {P}_{3} = {W}_{3} + \frac{( {R}_{3} + {G}_{3} + {B}_{3} )}{3} \\ {P}_{4} = {W}_{4} + \frac{( {R}_{4} + {G}_{4} + {B}_{4} )}{3}\end{matrix}$$

In the four calculated pixels above, in an order of two as a group, when a total brightness value P₁ of pixel on the left is larger than a total brightness value P₂ of the pixel on the right of the two pixels in the group on the left side, a sum of the brightness values of the W sub-pixels in the two pixels is averaged to be the brightness value of rendered W sub-pixel, and the total brightness values of the pixels on the right are regarded as the brightness values of rendered RGB three sub-pixels respectively, so as to obtain the second RGBW brightness value, a specific formula is:

$$\{ \begin{matrix}{W}_{{1}^{′}} = \frac{( {W}_{1} + {W}_{2} )}{2} \\ {R}_{{1}^{′}} = {P}_{2} \\ {G}_{{1}^{′}} = {P}_{2} \\ {B}_{{1}^{′}} = {P}_{2}\end{matrix}$$

As P₁ is dim and P₂ is bright, the result is a more sharp difference between contrasts in light, which can improve a display effect of words.

In the four calculated pixels, when a total brightness value P₃ of pixel on the left of the two pixels in the group on the right side is smaller than a total brightness value P₄ of the pixel on the right, the total brightness value P₃ of pixel on the left acts as the brightness value of rendered W sub-pixel, a sum of brightness values of RGB three sub-pixels respectively in the first RGBW brightness value of the two pixels is averaged to be brightness values of rendered RGB three-sub-pixels to obtain the second RGBW brightness values, the specific formula is:

$$\{ \begin{matrix}{W}_{{2}^{′}} = {P}_{3} \\ {R}_{{2}^{′}} = \frac{( {R}_{3} + {R}_{4} )}{2} \\ {G}_{{2}^{′}} = \frac{( {G}_{3} + {G}_{4} )}{2} \\ {B}_{{2}^{′}} = \frac{( {B}_{3} + {B}_{4} )}{2}\end{matrix} .$$

As P₃ is dim and P₄ is bright, the result is a more sharp difference between contrasts in light, which can improve a display effect of words.

In the rendering process above, most of the sub-pixel information is maintained, only some information of dim sub-pixels is abandoned, which has little influence on display details.

The examples of the word mode above are all illustrated in an arrangement of W in front of RGB sub-pixels. If the arrangement is W following the RGB sub-pixels, the process is reverse.

In the four calculated pixels above, in an order of two as a group, when a total brightness value P₁ of pixel on the left is smaller than a total brightness value P₂ of the pixel on the right of the two pixels in the group on the left side, a sum of the brightness values of the W sub-pixels in the first RGBW brightness value of the two pixels is averaged to be the brightness value of rendered W sub-pixel, and the total brightness value P₂ of the pixel on the right is regarded as the brightness value of rendered RGB three sub-pixels respectively, so as to obtain the second RGBW brightness value, a specific formula is:

$$\{ \begin{matrix}{W}_{{1}^{′}} = \frac{( {W}_{1} + {W}_{2} )}{2} \\ {R}_{{1}^{′}} = {P}_{2} \\ {G}_{{1}^{′}} = {P}_{2} \\ {B}_{{1}^{′}} = {P}_{2}\end{matrix}$$

In the four calculated pixels, when a total brightness value P₃ of pixel on the left of the two pixels in the group on the right side is smaller than a total brightness value P₄ of the pixel on the right, the total brightness value P₃ of pixel on the left acts as the brightness value of rendered W sub-pixel, a sum of brightness values of RGB three sub-pixels respectively in the first RGBW brightness value of the two pixels is averaged to be brightness values of rendered RGB three-sub-pixels to obtain the second RGBW brightness values, the specific formula is:

$$\{ \begin{matrix}{W}_{{2}^{′}} = {P}_{3} \\ {R}_{{2}^{′}} = \frac{( {R}_{3} + {R}_{4} )}{2} \\ {G}_{{2}^{′}} = \frac{( {G}_{3} + {G}_{4} )}{2} \\ {B}_{{2}^{′}} = \frac{( {B}_{3} + {B}_{4} )}{2}\end{matrix} .$$

In the disclosure, the processes of De-Gamma conversion and the Gamma conversion are achieved by following formulas respectively:

$$De \text{-} Gamma conversion \text{:} y = {( x / 255 )}^{gamma} ;$$

$$Gamma conversion \text{:} x = {( y / 255 )}^{\frac{1}{gamma}}$$

In the formulas above, y is the grayscale value, x is the brightness value, gamma is 2.2.

In the disclosure, converting the brightness values of RGB to the first RGBW brightness values can be achieved by:

$$\{ \begin{matrix}W = min ( k * R , k * G , k * B , {W}_{max} ) \\ R = k * R - W \\ G = k * G - W \\ B = k * B - W\end{matrix} \qquad$$

k is a gain coefficient assigned by display contents, 2.5≥k≥1.

The disclosure has following advantages.

(1): Adoption of the pixel rendering method can prevent practical resolution from reduction while physical resolution is decreased.

(2): All the sub-pixel information can be maintained in the process of pixel rendering, details will not be lost.

(3): The disclosure judges aiming at different display modes, the word mode and the image mode are processed respectively.

(4): The result of processing images is to smooth display effects of images, especially portraits.

(5): The result of processing words is to highlight difference between black and white in displaying words, details are further sharpened.

Although the disclosure is illustrated with reference to specific embodiments, a person skilled in the art should understand that various modifications on forms and details can be achieved within the spirit and scope of the disclosure limited by the claims and the counterpart.

What is claimed is:

1. A RGBW pixel rendering device, the rendering device comprising:
a collecting module, configured to obtain a RGB grayscale value of three primary color components of each pixel of an original image in a RGB color space, and send the RGB grayscale value to converters;
the converters, configured to obtain a brightness value of RGB by De-Gamma conversion of the RGB grayscale value and send the brightness value of RGB to a sampler, as well as obtaining a RGBW grayscale value of a pixel by Gamma conversion of a second RGBW brightness value and outputting the RGBW grayscale value;
the sampler, configured to convert the brightness value of RGB to a first RGBW brightness value and send the first RGBW brightness value to a rendering element;
a judging element, configured to obtain saturation values and brightness values of two pixels in each group in the original image with two pixels as a group, as well as obtaining a saturation difference and a brightness difference by respective subtraction of the saturation values and the brightness values; judging according to the saturation difference and the brightness difference of two pixels in each of the groups to obtain an outcome and sending the outcome to the rendering element;
the rendering element, configured to render the first RGBW brightness value according to the outcome to obtain the second RGBW brightness value after rendering and send the second RGBW brightness value to the converters for conversion.

2. The RGBW pixel rendering device according to claim 1, wherein the converters comprise a first converter and a second converter;
the first converter, configured to obtain the brightness value of RGB by De-Gamma conversion of the RGB grayscale value and send the brightness value of RGB to the sampler;
the second converter, configured to obtain the RGBW grayscale value of the pixel by Gamma conversion of the second RGBW brightness value and output the RGBW grayscale value.

3. The RGBW pixel rendering device according to claim 2, wherein a judging criterion of the judging element determining according to the saturation difference and the brightness difference of two pixels in each of the groups is judging if the saturation differences of each of the groups are less than a first threshold and the brightness differences of each of the groups are more than a second threshold, if the saturation differences of each of the groups are less than the first threshold and the brightness differences of each of the groups are more than the second threshold, the judging element votes the original image to be a word mode, otherwise, the judging element votes the original image to be an image mode.

4. The RGBW pixel rendering device according to claim 3, wherein when the outcome is the image mode, the rendering element renders by averaging a sum of the brightness values of sub-pixels of an identical type in the first RGBW brightness values of two pixels of each of the groups to obtain the second RGBW brightness value.

5. The RGBW pixel rendering device according to claim 3, wherein when the outcome is the word mode, the rendering element calculates total brightness values of the first RGBW brightness values of two pixels of each of the groups respectively, and judges the total brightness values of the two pixels to obtain the corresponding second RGBW brightness value, calculation of the total brightness value of the pixels follows a formula below:
$${P}_{n} = {W}_{n} + \frac{{R}_{n} + {G}_{n} + {B}_{n}}{3}$$
brightness values of four sub-pixels comprised in the first RGBW brightness value of the pixel are respectively Wₙ, Rₙ, Gₙ; Bₙ, n is a serial number of a position where the pixel is in the original image, Pₙ is the total brightness value of the pixel, the formula above obtains the total brightness value of the first RGBW brightness value of the pixel;
when the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value;
when the total brightness value of the pixels on the left is smaller than the total brightness value of the pixels on the right, the total brightness of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.

6. A RGBW pixel rendering method, comprising following steps:
step one S01, a collecting module obtaining a RGB grayscale value of three primary color components of each pixel of an original image in a RGB color space, and sending the RGB grayscale value to converters;
step two S02, the converters obtaining a brightness value of RGB by De-Gamma conversion of the RGB grayscale value and sending the brightness value of RGB to a sampler;
step three S03, the sampler converting the brightness value of RGB to a first RGBW brightness value and sending the first RGBW brightness value to a rendering element;
step four S04, a judging element obtaining saturation values and brightness values of two pixels in each group in the original image with two pixels as a group, obtaining a saturation difference and a brightness difference by respective subtraction of the saturation values and the brightness values, the judging element obtaining an outcome according to the saturation difference and the brightness difference of two pixels in each group to and sending the outcome to the rendering element;
step five S05, the rendering element rendering the first RGBW brightness value according to the received outcome to obtain the rendered second RGBW brightness value and sending the second RGBW brightness value to the converters for conversion;
step six S06, the converters obtaining a RGBW grayscale value of a pixel by Gamma conversion of a second RGBW brightness value and outputting the RGBW grayscale value.

7. The RGBW pixel rendering method according to claim 6, wherein the converters comprise a first converter and a second converter;
after the collecting module sends the RGB grayscale value to the converter, the first converter obtains the brightness value of RGB by De-Gamma conversion of the RGB grayscale value and sends the brightness value of RGB to the sampler;
after the rendering element sends the rendered second RGBW brightness value to the converters, the second converter obtains a RGBW grayscale value of the pixel by Gamma conversion of the second RGBW brightness value and outputs the RGBW grayscale value.

8. The RGBW pixel rendering method according to claim 7, wherein a judging criterion of the judging element determining according to the saturation difference and the brightness difference of two pixels in each of the groups is:
judging if the saturation differences of each of the groups are less than a first threshold and the brightness differences of each of the groups are more than a second threshold, if the saturation differences of each of the groups are less than the first threshold and the brightness differences of each of the groups are more than the second threshold, the judging element votes the original image to be a word mode, otherwise, the judging element votes the original image to be an image mode.

9. The RGBW pixel rendering method according to claim 8, wherein when the outcome is the image mode, the rendering element renders by averaging a sum of the brightness values of sub-pixels of an identical type in the first RGBW brightness values of two pixels of each of the groups to obtain the second RGBW brightness value.

10. The RGBW pixel rendering method according to claim 8, wherein when the outcome is the word mode, the rendering element calculates total brightness values of the first RGBW brightness values of two pixels of each of the groups respectively, and judges the total brightness value of the two pixels to obtain the corresponding second RGBW brightness value, calculation of the total brightness value of the pixels follows a formula below:
$${P}_{n} = {W}_{n} + \frac{{R}_{n} + {G}_{n} + {B}_{n}}{3}$$
brightness values of four sub-pixels comprised in the first RGBW brightness value of the pixel are respectively Wₙ, Rₙ, Gₙ and Bₙ, n is a serial number of a position where the pixel is in the original image, Pₙ is the total brightness value of the pixel, the formula above obtains the total brightness value of the pixel;
when the total brightness value of the pixel on the left of the two pixels in each of the groups is larger than the total brightness value of the pixel on the right of the two pixels in each of the groups, a sum of brightness values of a W sub-pixel in the first RGBW brightness value of the two pixels is averaged to be the brightness value of rendered W sub-pixel, the total brightness values of the pixels on the right side are regarded as brightness values of rendered RGB three sub-pixels respectively, so as to obtain the second RGBW brightness value;
when the total brightness value of the pixels on the left is smaller than the total brightness value of the pixels on the right, the total brightness value of the pixels on the left is regarded as the brightness value of rendered W sub-pixel, a sum of brightness values of a R sub-pixel in the first RGBW brightness value of the two pixels is averaged to be the brightness value of rendered R sub-pixel, a sum of brightness values of a G sub-pixel in the first RGBW brightness value of the two pixels is averaged to be the brightness value of rendered G sub-pixel, a sum of brightness values of a B sub-pixel in the first RGBW brightness value of the two pixels is averaged to be the brightness value of rendered B sub-pixel, the second RGBW brightness value is achieved.
